(19) United States
(12) Patent Application Publication
(10) Pub. No.: US 2003/0142426 A1
(43) Pub. Date: Jul. 31, 2003

(54) Multiple translational motion bump stops for movable structure having torsional hinge

(76) Inventor: Arthur monroe Turner, Allen, TX (US)

Correspondence Address: TEXAS INSTRUMENTS INCORPORATED, P O BOX 655474, M/S 3999, DALLAS, TX, 75265

(21) Appl. No.: 10/066,410

(22) Filed: Jan. 31, 2002

(51) Int. Cl. G02B 26/08; G02F 1/29; G02B 7/182

(52) U.S. Cl. 359/872; 359/876; 359/224; 359/298

(57) ABSTRACT

A device (21) comprises a movable structure (44) having a first movable portion (70) hinged to a frame portion (60) by a first pair of hinges (81, 82) spaced apart along a first axis (91). The first movable portion (70) has an edge (140) that is substantially parallel with and immediately adjacent to an edge (132) of the frame portion (60), and a first tolerance fit space (120) is defined therebetween. At least two projections (122) extend from one or both of the edges (132 and/or 140). The projections (122) are adapted to limit translational motion of the first movable portion (70) relative to the frame portion (60) within the plane. The projections (122) are substantially adjacent to each other and are on a same side of the first axis (91). The device (21) may also have a second movable portion (80) and a second pivot axis (112).

### FIELD OF THE INVENTION

The present invention relates to devices having at least one torsional hinge. In one aspect, it relates to optical devices, such as optical switch devices with movable mirrors used in an optical switch station for a communication network.

### BACKGROUND

In recent years optical fibers have come into wide spread use in a wide variety of applications in which optical signals are transmitted along such fibers and are switched from one optical fiber to another using an optical switch system. Movable mirror devices having torsional hinges are often used in such optical switching systems to reflect, route, and/or attenuate light of the optical signals. However, the durability and life span of current torsion-hinge movable mirror devices have suffered due to failures in the torsional hinge portions of the devices. The torsional hinge mirror devices often experience translational motion in the mirror surface plane due to vibrations and/or shock during manufacturing, handling, and shipping. In other words, translational movement of the mirror element in the plane of the mirror surface may cause a hinge of the movable mirror device to experience bending and/or shear forces in directions other than a generally intended direction of rotation (e.g., for tilting the mirror element during intended use of the device). Such unwanted or unintended forces are often the cause of failure for these devices. Hence, there is a need for a way to reduce or eliminate such unwanted or unintended forces experienced by the hinge members of a torsion-hinge movable mirror device.

The problem of translational motion and forces exerted on a torsional hinge may exist in other devices as well, other than movable mirror devices. Hence, there is generally a need for a way to reduce or eliminate unwanted or unintended translational motion and forces experienced by a torsional hinge in a device.

### BRIEF SUMMARY OF THE INVENTION

The problems and needs outlined above are addressed by the present invention. In accordance with one aspect of the present invention, a device having a movable structure is provided. The movable structure includes a frame portion, a first movable portion, and projections that act as translational bump stops. The first movable portion is hinged to the frame portion by a first pair of hinges spaced apart along a first axis, such that the first movable portion can pivot relative to the frame portion about the first axis, and such that the first pair of hinges act as torsional springs when the first movable portion pivots relative to the frame portion. The first movable portion has a first edge that is substantially parallel with and immediately adjacent to an edge of the frame portion, such that a first tolerance fit space exists between the first edge of the first movable portion and the frame portion edge. A first set of at least two projections extend from the first edge of the first movable portion and/or the frame portion edge, and extend within the first tolerance fit space. The first set of projections are adapted to limit translational motion of the first movable portion relative to the frame portion. The first set of projections are substantially adjacent to each other and are on a same side of the first axis.

In accordance with another aspect of the present invention, an optical device is provided. The optical device comprises a movable mirror having functional components lying within a plane defined by holes formed in a single piece of substantially planar material. The movable mirror components comprise: a frame portion; a first movable portion; and a first set of at least two projections. The first movable portion is hinged to the frame portion by a first pair of hinges spaced apart along a first axis in the plane. The first movable portion can pivot relative to the frame portion about the first axis. The first pair of hinges act as torsional springs when the first movable portion pivots relative to the frame portion. The first movable portion has a first edge that is substantially parallel with and immediately adjacent to an edge of the frame portion, such that a first tolerance fit space exists between the first edge of the first movable portion and the frame portion edge. The first set of at least two projections extend from the first edge of the first movable portion and/or the frame portion edge, and extend within the first tolerance fit space. The first set of projections are adapted to limit translational motion of the first movable portion relative to the frame portion. The first set of projections are substantially adjacent to each other and are on a same side of the first axis.

The first movable portion of the movable mirror may be an inner mirror portion having a reflective mirror surface formed thereon. The movable mirror components may further comprise a second movable portion. A second movable portion may be hinged to the first movable portion by a second pair of hinges spaced apart along a second axis in the plane, such that the second movable portion can pivot relative to the first movable portion about the second axis, and such that the second pair of hinges act as torsional springs when the second movable portion pivots relative to the first movable portion. A reflective mirror surface may be formed on the second movable portion, wherein the first movable portion is an intermediate gimbals portion and the second movable portion is an inner mirror portion. A second set of at least two projections may extend from at least one of an edge of the second movable portion and a second edge of the first movable portion, and extend within a second tolerance fit space formed between the second edge of the first movable portion and the second movable portion edge. The second edge of the first movable portion may be substantially parallel with the second movable portion edge, the second set of projections are adapted to limit translational motion of the second movable portion relative to the first movable portion, wherein the second set projections are substantially adjacent to each other and are on a same side of the second axis. The first axis may be (or may not be) substantially perpendicular to the second axis. At least one of the projections may have a shape that is generally triangular shape, generally half-circle shape, generally trapezoidal shape, generally rectangular shape, generally rounded shape, and/or arbitrarily shape. At least one of the projections may have a distal tip shape with a pointed distal tip, a rounded distal tip, and/or a blunt distal tip. There may be two, three, four, or more projections in the first set of projections and/or in the second set of projections. The edges defining the first tolerance fit space may be (or may not be) substantially parallel with the first axis and/or the second axis. The edges defining the seconds tolerance fit space may be (or may not be) substantially parallel with the first axis and/or the second axis. An optical switch station may comprise the optical device, wherein the optical device is an optical switch device in such case, and a communications network may comprise the optical switch station.

In accordance with yet another aspect of the present invention, a movable mirror having functional components lying within a plane defined by holes formed in a single piece of substantially planar material, is provided. The movable mirror includes a frame portion, a first movable portion, and a first set of at least two projections. The first movable portion is hinged to the frame portion by a first pair of hinges spaced apart along a first axis in the plane. The first movable portion can pivot relative to the frame portion about the first axis. The first pair of hinges act as torsional springs when the first movable portion pivots relative to the frame portion. The first movable portion has a first edge that is substantially parallel with and immediately adjacent to an edge of the frame portion, such that a first tolerance fit space exists between the first edge of the first movable portion and the frame portion edge. The first set of at least two projections extends from at least one of the first movable portion edge and the frame portion edge, and extends within the first tolerance fit space. The first set of projections is adapted to limit translational motion of the first movable portion relative to the frame portion. The first set of projections are substantially adjacent to each other and are on a same side of the first axis.

In accordance with still another aspect of the present invention, a movable mirror having functional components lying within a plane defined by holes formed in a single piece of substantially planar silicon crystal material, is provided. The movable mirror includes a frame portion, an intermediate gimbals portion, and an inner mirror portion. The frame portion forms a border around the movable mirror. The intermediate gimbals portion is hinged to the frame portion by a first pair of hinges. Each hinge of the first pair of hinges extends along a first axis in the plane. Each hinge of the first pair of hinges acts as a torsional spring when the intermediate gimbals portion pivots about the first axis relative to the frame portion. On each side of the first axis for each hinge of the first hinge pair, there is a first tolerance fit space formed between an outer edge of the intermediate gimbals portion and an inner edge of the frame portion. The outer edge of the intermediate gimbals portion is parallel with and adjacent to the inner edge of the frame portion at the first tolerance fit space. Extending within each first tolerance fit space, there is a first set of at least two adjacent projections extending from the outer edge of the intermediate gimbals portion and/or the inner edge of the frame portion. The first set of projections are adapted to limit translational motion of the intermediate gimbals portion relative to the frame portion. The inner mirror portion is hinged to the intermediate gimbals portion by a second pair of hinges. Each hinge of the second pair of hinges extends along a second axis in the plane. Each hinge of the second pair of hinges acts as a torsional spring when the inner mirror portion pivots about the second axis relative to the intermediate gimbals portion. The second axis is substantially perpendicular to the first axis. The inner mirror portion has a reflective mirror surface formed thereon. On each side of the second axis for each hinge of the second hinge pair, there is a second tolerance fit space formed between an outer edge of the inner mirror portion and an inner edge of the intermediate gimbals portion. The outer edge of the inner mirror portion is parallel with and adjacent to the inner edge of the intermediate gimbals portion at the second tolerance fit space. Extending within each second tolerance fit space, there is a second set of at least two adjacent projections extending from the outer edge of the inner mirror portion and/or the inner edge of the intermediate gimbals portion. The second set of projections are adapted to limit translational motion of the inner mirror portion relative to the intermediate gimbals portion. One or more of the projections of the first set of projections may extend from the inner edge of the frame portion and/or from the outer edge of the intermediate gimbals portion. One or more of the projections of the second set of projections may extend from the inner edge of the intermediate gimbals portion and/or from the outer edge of the inner mirror portion. An optical device may include the movable mirror. An optical switch station may include the optical device, wherein the optical device is an optical switch device in such case, and a communications network may include the optical switch station.

### BRIEF DESCRIPTION OF THE DRAWINGS

Other objects and advantages of the invention will become apparent upon reading the following detailed description and upon referencing the accompanying drawings, in which:

FIG. 1 is a schematic showing a cut-away side view of an optical switch station incorporating a preferred embodiment of the present invention;

FIG. 2 is a schematic showing a cut-away side view of the preferred embodiment of the present invention;

FIG. 3 is a top view of a movable mirror assembly of the preferred embodiment;

FIGS. 4a-8a are various views of a movable mirror of the preferred embodiment; and

FIGS. 8b-8d are enlarged top views showing variations of projections for differ embodiments of the present invention.

### DETAILED DESCRIPTION OF THE INVENTION

Referring now to the drawings, wherein like reference numbers are used herein to designate like elements throughout the various views, a preferred embodiment of the present invention is illustrated and described, as well as other embodiments. The figures are not necessarily drawn to scale, and in some instances the drawings may be exaggerated and/or simplified in places for illustrative purposes only. One of ordinary skill in the art will appreciate the many possible applications and variations of the present invention based on the following examples of possible embodiments of the present invention.

The present invention relates to a device with a movable structure that has torsional hinges. Such a device made in accordance with an embodiment of the present invention provides translational motion bump stops to reduce or eliminate damage to the device caused by translational motion or force on the torsional hinges.

Commonly assigned U.S. Pat. No. 6,295,154 by Laor, et al. is hereby incorporated by reference. U.S. Pat. No. 6,295,154 discloses an optical switching device having a movable mirror, which is magnetically-driven and which has torsional hinges.

FIGS. 1-7b illustrate a preferred embodiment of the present invention. FIG. 1 shows the layout of a matrix optical switch station 20 comprising a plurality of parallel optical switch devices 21 and 22. Only two optical switch devices 21, 22 are shown in FIG. 1 (for purposes of illustration), but any number can be provided as needed or desired. These optical switch devices 21, 22 are mounted in a frame 24 such that they are aligned with an optical switch mirror 26. Both the optical switch device frame 24 and the optical switch mirror 26 are fixedly mounted in a housing 28 for the station 20. Fiber optic cables 31 and 32 are mounted in selected fixed positions within the housing 28 and fed into the optical switch devices 21, 22, respectively. In use, an optical signal 34 is transmitted in fiber optic cable 32, for example, and is directed and aimed by optical switch device 22 to another selected optical switch device, such as device 21, by reflection off of the optical switch mirror 26. Then, the optical switch device 21 directs the optical signal 34 into its corresponding cable 31. The optical signal 34 is optimized to minimize transmission losses by the optical switch devices 21, 22.

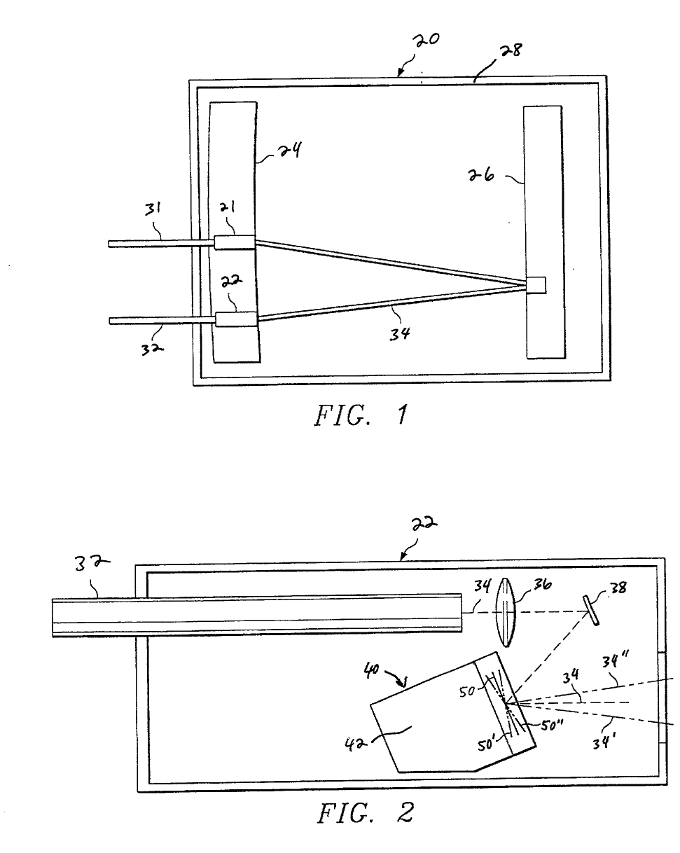

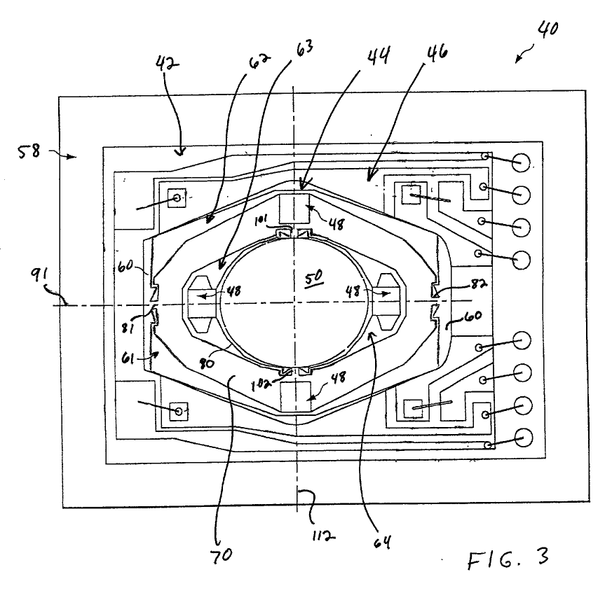

FIG. 2 is an enlarged, cut-away view of the lower optical switch device 22 of FIG. 1. As seen in FIG. 2, the optical signal beam 34 carried by optical cable 32 is focused by a lens 36 and is reflected by a fixed mirror 38 mounted within the optical switch device 22 to a moveable mirror assembly 40. The movable mirror assembly 40 comprises a control unit 42 and a movable mirror 44. The control unit 42 comprises bonnet-coils (not shown), mirror position sensors (not shown), and control circuitry 46 (see FIG. 3). The bonnet-coils are used to generate magnetic fields, which drive and control the movement of the movable mirror 44, which has permanent magnets and/or magnet material 48 attached thereto (only some of them shown in FIG. 3). The mirror position sensors detect the current position or angular orientation of the movable mirror 44, and the control circuitry 46 provides the electronics to drive and control the movable mirror 44.

In FIG. 2, a mirror element 50 of the movable mirror assembly 40 is shown as a solid line in its middle or neutral position (i.e., undriven position). The mirror element 50 is moveable between two opposite extremes, as illustrated by the phantom lines 51, 52. Hence in a neutral position (solid line 50), optical signal beam 34 is reflected at an angle corresponding to the angular orientation of the mirror element 50 in the neutral position, as illustrated by optical reflection path 34. Similarly for the extreme positions 50′ and 50″, optical signal beam 34 is reflected from the mirror element 50 at an angle corresponding to the angular orientation of the mirror element 50, as illustrated by optical reflection paths 34′ and 34″, respectively. Although the movement of the mirror element 50 shown in FIG. 2 illustrates movement in only one plane, mirror movement in other planes is also included in the operation of the optical switch device 22, as will be described below.

FIG. 3 shows a front view of the movable mirror assembly 40. The movable mirror 44 is mounted in a header 58. The movable mirror 44 has a frame portion 60 that is fixedly attached to the header 58, while other portions of the movable mirror 44, such as the reflective mirror element 50, can move within the header 58. Part of the control circuitry 46 is shown in FIG. 3 around and adjacent to the movable mirror 44. More circuitry (not shown) of the control circuitry 46 lies beneath the movable mirror 44 and within the header 58. Other components of the movable mirror assembly 40 are described in U.S. Pat. No. 6,295,154, and such components may vary for a given embodiment of the present invention.

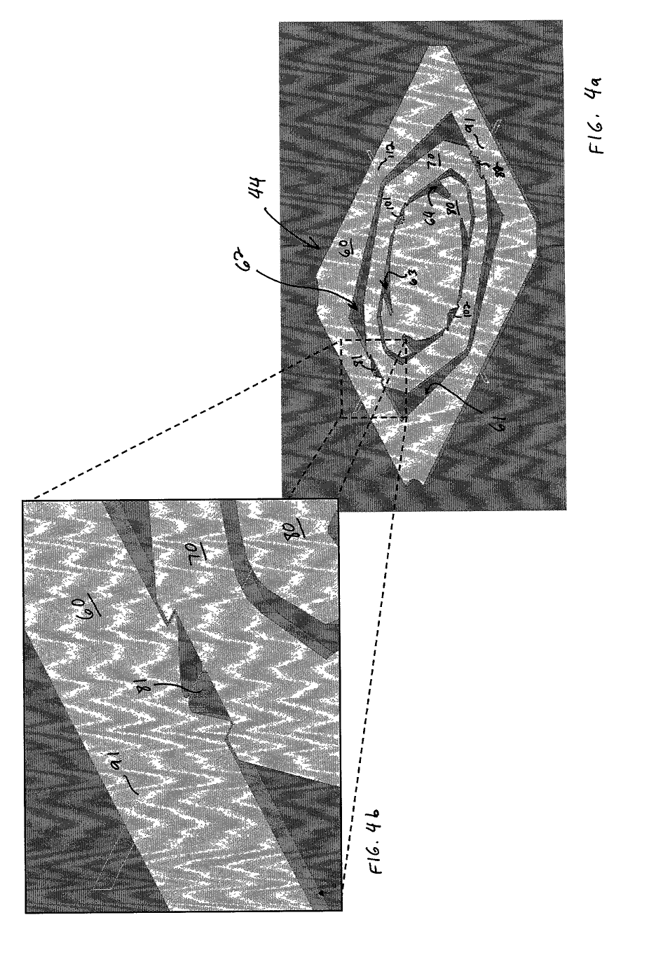

FIG. 4a shows a perspective view of the movable mirror 44 of FIG. 3. The movable mirror 44 comprises numerous functional components within a single plane. The movable mirror 44 is formed from a single piece of substantially planar material and the functional components of the movable mirror 44 are defined by openings or holes 61-64 formed in the planar sheet of material. Preferably, the movable mirror 44 is formed from one piece of single crystal material, such as silicon. Some of the functional components of the movable mirror 44 include the frame portion 60, an intermediate gimbals portion 70, and an inner mirror portion 80. In the preferred embodiment, the silicon is masked, exposed, and etched to form the openings or holes 61-64 that define the functional components. Note that the shape and size of the holes 61-64 used to define the functional components of the movable mirror 44 may vary from those shown in the preferred embodiment of the present invention herein. Hence, the size and shape of the functional components of the movable mirror 44 may vary for other embodiments of the present invention.

The intermediate gimbals portion 70 is hinged to the frame portion 60 at two ends by a first pair of hinges 81, 82 spaced apart and aligned along a first axis 91. Other than the first pair of hinges 81, 82, the intermediate gimbals portion 70 is separated from the frame portion 60 holes 61, 62 formed in the plate of silicon crystal of the movable mirror 44 (one on each side of the first axis 91). Hence, the intermediate gimbals portion 70 can pivot about the first axis 91 on the first pair of hinges 81, 82 relative to the frame portion 60. When the intermediate gimbals portion 70 pivots relative to the frame portion 60, the first pair of hinges 81, 82 act as torsional springs. The plate of silicon crystal of the movable mirror 44 for the preferred embodiment has a thickness on the order of 100 microns. FIG. 4b is an enlarged view of part of the movable mirror 44 shown in FIG. 4a. As shown in FIG. 4b, each hinge 81, 82 is much thinner (in width) than the thickness of the movable mirror 44. The width of the hinges 81, 82 is on the order of 10 microns. However, in other embodiments of the present invention, the thickness of the movable mirror 44 and/or the width of the hinges 81, 82 may vary (i.e., thinner, thicker) as needed or as desired. Changing the dimensions of the hinges 81, 82 will change the effective spring rate of the hinges 81, 82, as well as the strength and durability of the hinges 81, 82. Thus, there is a balance between the desired spring rate for the hinges 81, 82 and the desired strength and durability of the hinges 81, 82.

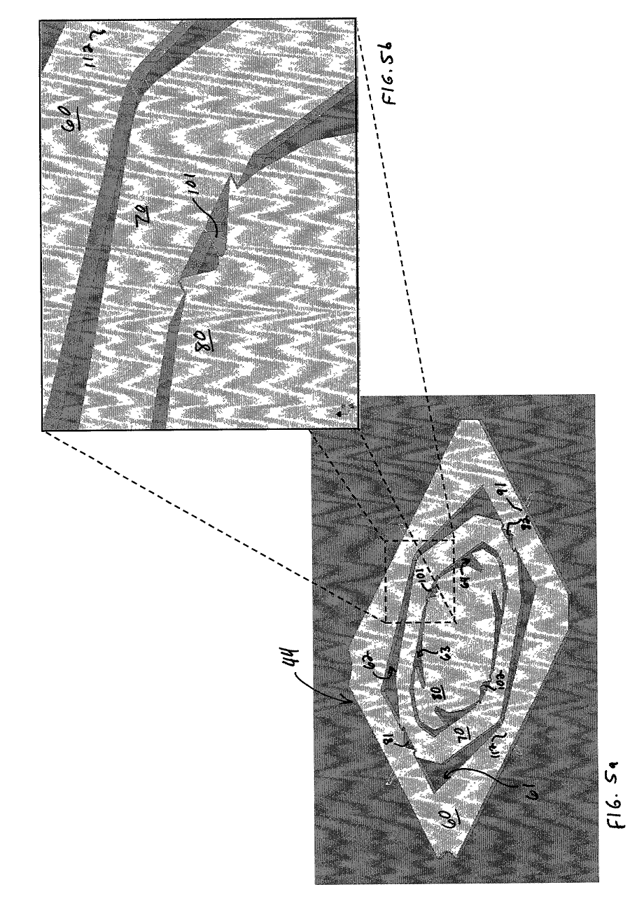

FIG. 5a shows the movable mirror 44 of FIG. 4a again. Referring to FIGS. 5a and 5b, the inner mirror portion 80 is coupled to the intermediate gimbals portion 70 at two ends by a second pair of hinges 101, 102 spaced apart and aligned along a second axis 112. In the preferred embodiment, the first axis 91 is substantially perpendicular to the second axis 112. However in other embodiments, the first axis 91 may not be perpendicular to the second axis 112. Other than the second pair of hinges 101, 102, the inner mirror portion 80 is separated from the intermediate gimbals portion 70 on each side of the second axis 112 by holes 63, 64 formed in the plate of silicon crystal of the movable mirror 44. Hence, the inner mirror portion 80 can pivot about the second axis 112 on the second pair of hinges 101, 102 relative to the intermediate gimbals portion 70. When the inner mirror portion 80 pivots relative to the intermediate gimbals portion 70, the second pair of hinges 101, 102 also act as torsional springs. FIG. 5b is an enlarged view of part of the movable mirror 44 shown in FIG. 5a. As shown in FIG. 5b, each hinge of the second pair of hinges 101, 102 is also much thinner (in width) than the thickness of the movable mirror 44. The width of the hinges of the second pair of hinges 101, 102 is on the order of 10 microns. However, in other embodiments of the present invention, the hinge widths of the second pair of hinges 101, 102 also may vary (i.e., thinner, thicker) as needed or as desired.

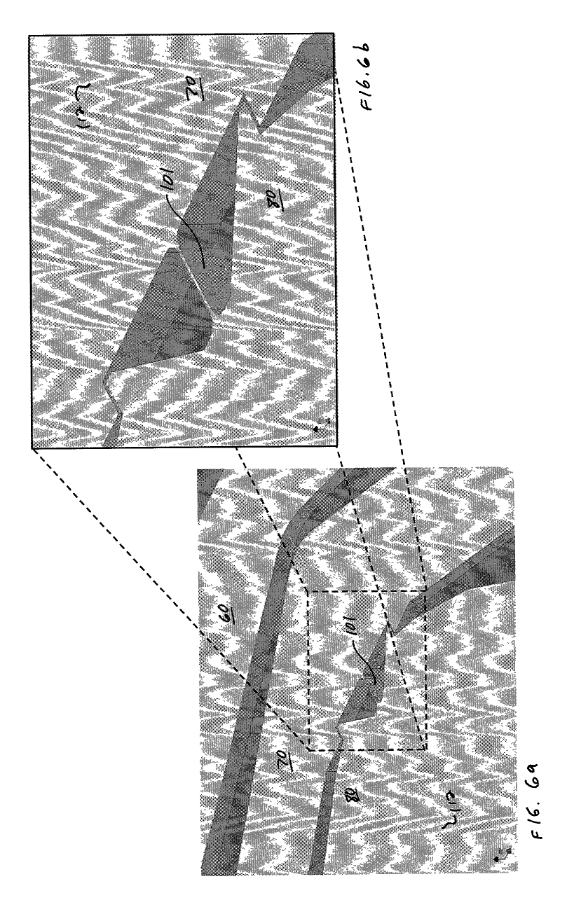

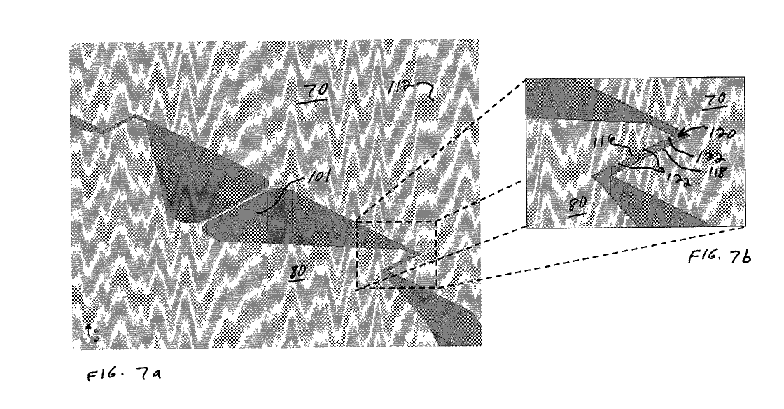

FIG. 6a shows the part of the movable mirror 44 of FIG. 5b again, and FIG. 6b is a further enlarged view of one of the hinges 101 of the second hinge pair to show further details of this region. FIG. 7a shows the part of the movable mirror 44 of FIG. 6b again, and FIG. 7b is a enlarged view of a translational motion stop region of the movable mirror 44 from FIG. 7a. Referring to FIG. 7a, the inner mirror portion 80 has an outer edge 116 that is substantially parallel with and immediately adjacent to an inner edge 118 of the intermediate gimbals portion 70, and a tolerance fit space 120 exists therebetween. This tolerance fit space is about 10 microns wide. This region shown in FIG. 7b is a translational motion stop to limit translational motion in a direction that would bring the two edges 116, 118 toward each other. Due to the high aspect ratio of the tolerance fit space 120 relative to the thickness of the movable mirror 44, it is difficult and impractical to accurately etch this space to a higher tolerance level (i.e., smaller than 10 microns wide). As disclosed in U.S. Pat. No. 6,295,154, a bump projection can be formed within the tolerance fit space 120 that extends from the outer edge 116 of the inner mirror portion 80 or from the inner edge 118 of the intermediate gimbals portion 70. Such a bump projection allows for an improved or closer tolerance at the bump projection to further limit translation movement of the inner mirror portion 80 relative to the intermediate gimbals portion 70.

As shown in FIG. 7b, the preferred embodiment of the present invention has not just one bump projection extending within the tolerance fit space 120, but three adjacent bump projections 122 extending within the tolerance fit space 120 from the outer edge 116 of the inner mirror portion 80. The inventor of the present invention found that by having two or more adjacent bump projections 122 extending within the tolerance fit space 120 from either or both of the edges 116, 118 defining the tolerance fit space 120, the translational motion can be further limited, which further limits the unintended forces that are experienced by the hinge 101. By further limiting the translational motion, the reliability, life, and durability of the movable mirror 44 is further improved. Because the hinges 81, 82, 101, 102 are typically one of the first components to fail in an optical switch device 22 having a movable mirror 44 with torsional hinges, an improvement to the reliability, life, and durability of the movable mirror 44 may yield a direct improvement on the reliability, life, and durability of an optical switch device 22 or an optical switch station 20 that incorporates such movable mirrors 44.

Due to the thickness of the movable mirror 44 (e.g., about 100 microns) relative to the size of the tolerance fit space 120 (e.g., about 10 microns), as one portion (e.g., inner mirror portion 80) pivots relative to another portion (e.g., intermediate gimbals portion 70) about an axis (e.g., second axis 112), the projections 122 move closer to the opposing edge and further limit the translational movement between the two portions. Hence for the range of pivotal movement of the movable mirror 44 during typical use (e.g., in an optical switch device 22), the projections 122 act as translational motion bump stops over the entire range of pivot motion for the movable mirror 44, and the ability to limit translational movement improves as the tilt angle increases.

Although only one of the tolerance fit spaces 120 is shown with greater detail in FIG. 7b, there are also other tolerance fit spaces 120, each with multiple projections 122 extending therein in accordance with the present invention, formed at other locations on the movable mirror 44. Referring back to FIGS. 4a, 4b, 5a, and 5b, specifically for the preferred embodiment shown, there are a total of eight tolerance fit spaces 120, each with multiple projections 122 extending therein in accordance with the present invention. As shown in FIG. 5a, there is a tolerance fit space 120, with multiple projections 122 extending therein in accordance with the present invention, formed on each side of the second axis 112 adjacent to each hinge of the second hinge pair 101, 102 (four total adjacent to the second axis 112). As shown in FIGS. 4a and 4b, there is a tolerance fit space 120, with multiple projections 122 extending therein in accordance with the present invention, formed on each side of the first axis 91 adjacent to each hinge of the first hinge pair 81, 82 (four total adjacent to the first axis 91). Thus in the preferred embodiment, the bump projections 122 adjacent to the first axis 91 act as bump stops and limit translational motion in directions generally perpendicular to the first axis 91. Similarly, the bump projections 122 adjacent to the second axis 112 act as bump stops and limit translational motion in directions generally perpendicular to the second axis 112.

In the preferred embodiment, the tolerance fit spaces 120 adjacent to the first axis 91 lie parallel with the first axis 91. In other words, the edges defining the tolerance fit spaces 120 adjacent to the first axis 91 are parallel to the first axis 91 in the preferred embodiment (see FIGS. 4a and 4b). Similarly, the edges 116, 118 defining the tolerance fit spaces 120 adjacent to the second axis 112 are parallel to the second axis 112 in the preferred embodiment (see FIGS. 5a and 5b). However, the edges defining the tolerance fit spaces 120 need not be parallel to first axis 91 nor the second axis 112. Therefore in other embodiments, the edges defining the tolerance fit spaces 120 may be at any angle relative to the first and second axis 91, 112.

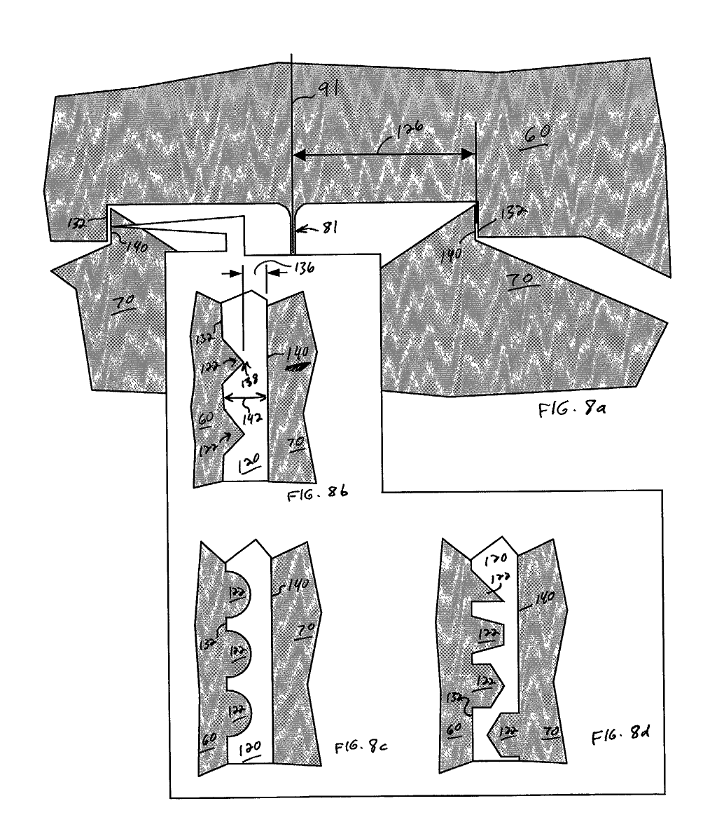

U.S. Pat. No. 6,295,154 only discloses triangular-shaped bump projections (see FIG. 5 of U.S. Pat. No. 6,295,154). In the preferred embodiment of the present invention, the multiple bump projections 122 are half-circle shaped with a rounded tip profile (as shown in FIG. 8c). FIG. 8a is a top view of the hinge and translational bump stop region of FIG. 4b. In FIG. 8a, the distance 126 between the first axis 91 and tip of the projections 122 (projections not visible in FIG. 8a) in the tolerance fit space 120 is the radius of an arc traversed by the projections 122 as the intermediate gimbals portion 70 pivots relative to the frame portion 60.

FIGS. 8b, 8c, and 8d are enlarged views of tolerance fit spaces 120 having multiple bump projections 122 extending therein for other embodiments of the present invention. In FIG. 8b, the projections 122 are both generally triangular shaped and each extends from an inner edge 132 of the frame portion 60. Notice in FIG. 8b that the distance 136 between the tip 138 of the projections 122 and the opposing edge 140 is about half that of the distance 142 between the edges 132, 140 defining the tolerance fit space 120, and hence, the distance 136 that the intermediate gimbals portion 70 can traverse laterally (translational motion) before being stopped by the projections 122 is about half that which it would be if there were not projections 122.

FIG. 8c shows the projections 122 of the preferred embodiment, which are half-circle shaped. The inventor found that the half-circle-shaped projections 122 with rounded tip profiles are preferable over the triangular-shaped projections with pointed tip profiles. Although FIGS. 8b and 8c show the projections 122 extending from only one edge 132 (i.e., all of the projections 122 extending from the frame portion edge 132), the multiple projections 122 may extend from either edge 132 or 140. Also, as shown in the embodiment of FIG. 8d, the projections 122 may extend from both edges 132 and 140.

Furthermore, although the shape of each projection 122 is the same and uniform for the embodiments shown in FIGS. 8b and 8c, in other embodiments of the present invention, a projection 122 may have a different shape from another adjacent projection 122 and/or from other projections 122 within the same tolerance fit space 120 and/or within the same embodiment. This is illustrated in the embodiment shown in FIG. 8d, which has four projections 122 within a tolerance fit space 120, and each projection 122 has a different shape.

Still further, the number of projections 122 within a tolerance fit space 120 is only limited by the space constraints of the tolerance fit space 120 (i.e. the length of the tolerance fit space 120). Hence, there may be two projections 122 (see FIG. 8b), three projections 122 (see FIG. 8c), four projections 122 (see FIG. 8d), or more within each of the tolerance fit spaces 120. Generally, the more projections 122 that can be formed within a given tolerance fit space 120, the better the performance in limiting translational movement. Therefore, the number, size, and position of the multiple projections for an embodiment may vary in any combination.

The embodiments shown and discussed thus far have each had the capability for pivotal movement in first and second axis 91, 112. However, in a more simplified and limited embodiment, there may be only one pair of hinges and only one pivotal axis (not shown); thus limiting such embodiment to pivotal movement about the one axis. In such case, there would be no intermediate gimbals portion 70. Likewise, a more complex embodiment of the present invention may have more than two pivotal axis (e.g., three axis and two intermediate gimbals portions) (not shown). An advantage of the present invention is that multiple projections may be incorporated into an existing design without having to completely redesign or reconfigure the etching patterns, other than any needed allowances for forming the projections.

Although the preferred embodiment shown and discussed herein is an optical switch application, other embodiments of the present invention may be incorporated into other types of optical devices, such as add-drop multiplexers, for example. Also, the present invention may be incorporated into other types of devices (other than optical devices), such as a butterfly valve for controlling or directing fluid flow, for example. Therefore, a movable structure with torsional hinges and translational bump stops in accordance with the present invention may be incorporated into a wide range of devices and systems.

It will be appreciated by those skilled in the art having the benefit of this disclosure that an embodiment of the present invention provides an improved translational motion stop to, among other things, extend the life of torsional hinges for movable structures. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A device, comprising:
a movable structure comprising:
a frame portion;
a first movable portion hinged to the frame portion by a first pair of hinges spaced apart along a first axis, such that the first movable portion can pivot relative to the frame portion about the first axis, and such that the first pair of hinges act as torsional springs when the first movable portion pivots relative to the frame portion;
the first movable portion having a first edge that is substantially parallel with and immediately adjacent to an edge of the frame portion, such that a first tolerance fit space exists between the first edge of the first movable portion and the frame portion edge; and
a first set of at least two projections extending from at least one of the first edge of the first movable portion and the frame portion edge, and extending within the first tolerance fit space, the first set of projections being adapted to limit translational motion of the first movable portion relative to the frame portion, wherein the first set of projections are substantially adjacent to each other and are on a same side of the first axis.

2. The device of claim 1, wherein the device is an optical device, and wherein the first movable portion of the movable mirror is an inner mirror portion having a reflective mirror surface formed thereon.

3. An optical device, comprising:
a movable mirror having functional components lying within a plane defined by holes formed in a single piece of substantially planar material, the movable mirror components comprising:
a frame portion;
a first movable portion hinged to the frame portion by a first pair of hinges spaced apart along a first axis in the plane, such that the first movable portion can pivot relative to the frame portion about the first axis, and such that the first pair of hinges act as torsional springs when the first movable portion pivots relative to the frame portion;
the first movable portion having a first edge that is substantially parallel with and immediately adjacent to an edge of the frame portion, such that a first tolerance fit space exists between the first edge of the first movable portion and the frame portion edge; and
a first set of at least two projections extending from at least one of the first edge of the first movable portion and the frame portion edge, and extending within the first tolerance fit space, the first set of projections being adapted to limit translational motion of the first movable portion relative to the frame portion, wherein the first set of projections are substantially adjacent to each other and are on a same side of the first axis.

4. The optical device of claim 3, wherein the first movable portion of the movable mirror is an inner mirror portion having a reflective mirror surface formed thereon.

5. The optical device of claim 3,
wherein the movable mirror components further comprise:
a second movable portion hinged to the first movable portion by a second pair of hinges spaced apart along a second axis in the plane, such that the second movable portion can pivot relative to the first movable portion about the second axis, and such that the second pair of hinges act as torsional springs when the second movable portion pivots relative to the first movable portion; and
a reflective mirror surface formed on the second movable portion, wherein the first movable portion is an intermediate gimbals portion and the second movable portion is an inner mirror portion.

6. The optical device of claim 3,
wherein the movable mirror components further comprise:
a second set of at least two projections extending from at least one of an edge of the second movable portion and a second edge of the first movable portion, and extending within a second tolerance fit space formed between the second edge of the first movable portion and the second movable portion edge, wherein the second edge of the first movable portion is substantially parallel with the second movable portion edge, the second set of projections being adapted to limit translational motion of the second movable portion relative to the first movable portion, wherein the second set projections are substantially adjacent to each other and are on a same side of the second axis.

7. The optical device of claim 3, wherein the first axis is substantially perpendicular to the second axis.

8. The optical device of claim 3, wherein at least one of the projections has a shape selected from a group consisting of a generally triangular shape, a generally half-circle shape, a generally trapezoidal shape, a generally rectangular shape, a generally rounded shape, and an arbitrary shape.

9. The optical device of claim 3, wherein at least one of the projections has a distal tip shape selected from a group consisting of a pointed distal tip, a rounded distal tip, and a blunt distal tip.

10. The optical device of claim 3, wherein there are two projections in the first set of projections.

11. The optical device of claim 3, wherein there are three projections in the first set of projections, and there are three projections in the second set of projections.

12. The optical device of claim 3, wherein there are four projections in the first set of projections.

13. The optical device of claim 3, wherein the edges defining the first tolerance fit space are substantially parallel with the first axis.

14. The optical device of claim 3, wherein the edges defining the first tolerance fit space are not parallel with the first axis nor with the second axis.

15. The optical device of claim 3, wherein the edges defining the second tolerance fit space are substantially parallel with the second axis.

16. The optical device of claim 3, wherein the edges defining the second tolerance fit space are not parallel with the second axis nor with the first axis.

17. An optical switch station comprising the optical device of claim 3, wherein the optical device is an optical switch device.

18. A communications network comprising the optical switch station of claim 17.

19. A movable mirror having functional components lying within a plane defined by holes formed in a single piece of substantially planar material, comprising:
a frame portion;
a first movable portion hinged to the frame portion by a first pair of hinges spaced apart along a first axis in the plane, such that the first movable portion can pivot relative to the frame portion about the first axis, and such that the first pair of hinges act as torsional springs when the first movable portion pivots relative to the frame portion;
the first movable portion having a first edge that is substantially parallel with and immediately adjacent to an edge of the frame portion, such that a first tolerance fit space exists between the first edge of the first movable portion and the frame portion edge; and
a first set of at least two projections extending from at least one of the first edge of the first movable portion and the frame portion edge, and extending within the first tolerance fit space, the first set of projections being adapted to limit translational motion of the first movable portion relative to the frame portion, wherein the first set of projections are substantially adjacent to each other and are on a same side of the first axis.

20. A movable mirror having functional components lying within a plane defined by holes formed in a single piece of substantially planar silicon crystal material, the movable mirror comprising:
a frame portion forming a border around the movable mirror;
an intermediate gimbals portion hinged to the frame portion by a first pair of hinges, each hinge of the first pair of hinges extending along a first axis in the plane, such that each hinge of the first pair of hinges acts as a torsional spring when the intermediate gimbals portion pivots about the first axis relative to the frame portion;
on each side of the first axis for each hinge of the first hinge pair, there is a first tolerance fit space formed between an outer edge of the intermediate gimbals portion and an inner edge of the frame portion, wherein the outer edge of the intermediate gimbals portion is parallel with and adjacent to the inner edge of the frame portion at the first tolerance fit space, and
extending within each first tolerance fit space, there is a first set of at least two adjacent projections extending from at least one of the outer edge of the intermediate gimbals portion and the inner edge of the frame portion, the first set of projections being adapted to limit translational motion of the intermediate gimbals portion relative to the frame portion;
an inner mirror portion hinged to the intermediate gimbals portion by a second pair of hinges, each hinge of the second pair of hinges extending along a second axis in the plane, such that each hinge of the second pair of hinges acts as a torsional spring when the inner mirror portion pivots about the second axis relative to the intermediate gimbals portion, wherein the second axis is substantially perpendicular to the first axis, and the inner mirror portion has a reflective mirror surface formed thereon; and
on each side of the second axis for each hinge of the second hinge pair, there is a second tolerance fit space formed between an outer edge of the inner mirror portion and an inner edge of the intermediate gimbals portion, wherein the outer edge of the inner mirror portion is parallel with and adjacent to the inner edge of the intermediate gimbals portion at the second tolerance fit space, and
extending within each second tolerance fit space, there is a second set of at least two adjacent projections extending from at least one of the outer edge of the inner mirror portion and the inner edge of the intermediate gimbals portion, the second set of projections being adapted to limit translational motion of the inner mirror portion relative to the intermediate gimbals portion.

21. The movable mirror of claim 20, wherein at least one of the projections of the first set of projections extends from the inner edge of the frame portion.

22. The movable mirror of claim 20, wherein at least one of the projections of the first set of projections extends from the outer edge of the intermediate gimbals portion.

23. The movable mirror of claim 20, wherein at least one of the projections of the second set of projections extends from the inner edge of the intermediate gimbals portion.

24. The movable mirror of claim 20, wherein at least one of the projections of the second set of projections extends from the outer edge of the inner mirror portion.

25. An optical device comprising the movable mirror of claim 20.

26. An optical switch station comprising the optical device of claim 25, wherein the optical device is an optical switch device.

27. A communications network comprising the optical switch station of claim 26.
